(19) United States
(12) Patent Application Publication
(10) Pub. No.: US 2015/0223231 A1
(43) Pub. Date: Aug. 6, 2015

(54) UPLINK CONTROL CHANNEL, AND METHOD AND APPARATUS FOR CONTROLLING TRANSMISSION OF SOUNDING REFERENCE SIGNAL

(71) Applicant: KT CORPORATION, Gyeonggi-do (KR)

(72) Inventor: Minseok Noh, Seoul (KR)

(21) Appl. No.: 14/421,562

(22) PCT Filed: Aug. 9, 2013
(86) PCT No.: PCT/KR2013/007218

§ 371 Date: Feb. 13, 2015

(30) Foreign Application Priority Data
Aug. 16, 2012 (KR) 10-2012-0089754
Jul. 29, 2013 (KR) 10-2013-0089752

(51) Int. Cl. H04W 72/04; H04W 76/04

(52) U.S. Cl. CPC H04W 72/0413; H04W 76/046; H04W 72/042

(57) ABSTRACT

The present disclosure relates to a method and apparatus for transmitting a sounding reference signal. The method may include receiving first and second configuration information where the first configuration information includes cell-specific SRS configuration information for a second base station which is distinguishable from the first base station transmitting the downlink signal, and the second configuration information includes information used for generating sequences for transmitting the uplink control channel and the sounding reference signal to the second base station, generating sequences for the uplink control channel and the sounding reference signal based on the second configuration information, and configuring the transmission of the uplink control channel and the sounding reference signal to the second base station based on the first configuration information, and transmitting the configured uplink control channel and the sounding reference signal to the second base station.

### TECHNICAL FIELD

The present disclosure relates to an uplink control channel and a method and an apparatus for controlling transmission of a sounding reference signal, and more particularly, to a method and an apparatus for multiplexing a signal in order to prevent signal interference between two adjacent user equipment when a base station having transmitted a downlink signal is different from a base station which will receive an uplink signal.

### BACKGROUND ART

Advances in communication systems enable consumers such as companies and individuals to use various types of wireless terminals. Current mobile communication systems have employed 3GPP technologies, for example, Long Term Evolution (LTE), LTE-Advanced (LTE-A), and the like. Such a mobile communication system can transmit a large amount of data which is similar to that of a wired communication network. The mobile communication system has been required to be realized as a high-speed high-capacity communication system for transmitting/receiving various types of data such as a video, wireless data, etc. as well as voice. An example of a scheme of transmitting a large amount of data corresponds to a scheme of efficiently transmitting data using a plurality of cells.

However, in the related art, when communication is performed using a plurality of cells or base stations, there is a problem with the control of an uplink control channel and transmission of a sounding reference signal.

### DETAILED DESCRIPTION OF THE INVENTION

### Technical Problem

In order to solve the aforementioned problem, present disclosure method and an apparatus are proposed for preventing interference between signals of one UE or signals between two adjacent UE associated with a reception base station when a UE transmits an uplink control channel and a sounding reference signal to the reception base station, where the reception base station is different from a transmission base station having received a downlink control channel.

### Technical Solution

The present disclosure provides a method of enabling PUCCH multiplexing between different UEs when a UE, which belongs to a predetermined cell/base station/RRH/antenna/RU/point, i.e., has received a downlink control channel through the corresponding cell/base station/RRH/antenna/RU/point, supports transmission of an uplink control channel, i.e., a PUCCH and an SRS to another cell/base station/RRH/antenna/RU/point different from the cell/base station/RRH/antenna/RU/point having a better channel quality and a better uplink geometry, and relates to a detailed method and an apparatus for solving ambiguity of a UE for the transmission of a PUCCH and an SRS from the viewpoint of one UE.

In accordance with an embodiment of the present disclosure, a method of transmitting an uplink control channel and a sounding reference signal by a UE is provided.

The method includes: receiving first configuration information including cell-specific SRS configuration information of a second base station which is distinguished from a first base station transmitting a downlink signal and second configuration information including information used for generating respective sequences for transmitting the uplink control channel and the sounding reference signal to the second base station; generating the respective of the uplink control channel and the sounding reference signal on the basis of the second configuration information, and configuring transmission of the uplink control channel and the sounding reference signal to the second base station on the basis of the first configuration information; transmitting the configured uplink control channel and the configured sounding reference signal to the second base station.

Further, in accordance with another embodiment of the present disclosure, a method of controlling transmission of an uplink control channel and a sounding reference signal of a UE by a base station is provided.

The method includes: generating first configuration information including cell-specific SRS configuration information of another base station which is distinguished from the base station and second configuration information including information used for generating respective sequences for transmitting the uplink control channel and the sounding reference signal to the another base station; and transmitting the first configuration information and the second configuration information to the UE through high layer signaling, wherein the another base station receives the uplink control channel and the sounding reference signal, which are generated using the first configuration information and the second configuration information.

In accordance with yet another embodiment of the present disclosure, a UE for transmitting an uplink control channel and a sounding reference signal is provided. The UE includes: a reception unit for receiving, from a first base station, first configuration information including cell-specific SRS configuration information of a second base station which is distinguished from a first base station transmitting a downlink signal and second configuration information including information used for generating respective sequences for transmitting the uplink control channel and the sounding reference signal to the second base station; a controller for generating respective sequences of the uplink control channel and the sounding reference signal on the basis of the second configuration information, and configuring transmission of the uplink control channel and the sounding reference signal to the second base station on the basis of the first configuration information; and a transmission unit for transmitting the configured uplink control channel and the configured sounding reference signal to the second base station.

Further, in accordance with yet another embodiment of the present disclosure, a base station for controlling transmission of an uplink control channel and a sounding reference signal is provided. The base station includes: a reception unit for receiving an uplink signal from a UE; a controller for generating first configuration information including cell-specific SRS configuration information of another base station which is distinguished from a base station receiving the uplink signal and second configuration information including information used for generating respective sequences for transmitting an uplink control channel and a sounding reference signal to the another base station; and a transmission unit for transmitting the first configuration information and the second configuration information to the UE through high layer signaling, wherein the another base station receives the uplink control signal and the sounding reference signal which are generated using the first configuration information or the second configuration information.

### Advantageous Effects

When implementing the present disclosure, a UE, which belongs to a predetermined cell/base station/RRH/antenna/RU, i.e., receives a downlink control channel through the corresponding cell/base station/RRH/antenna/RU, supports transmission to a cell/base station/RRH/antenna/RU, which is different from the cell/base station/RRH/antenna/RU having a better channel quality and a better geometry of an uplink, thereby overcoming a coverage for an uplink control channel and an uplink data channel of the uplink. Further, the UE can measure a state of an uplink channel with another cell/base station/RRH/antenna/RU, which is different from the serving cell/base station/RRH/antenna/RU, through transmission of a periodic or aperiodic sounding reference signal, thereby overcoming coverage shortage of an uplink.

### BRIEF DESCRIPTION OF THE DRAWINGS

FIG. 1 illustrates a typical method of transmitting uplink/downlink data;

FIG. 2 illustrates a typical method of transmitting uplink/downlink data;

FIG. 3 illustrates a case where UEs belonging to different cells transmit an uplink related channel to the same base station according to an embodiment;

FIG. 4 illustrates a case where UEs belonging to different base stations transmit an uplink related channel to the same base station according to another embodiment;

FIG. 5 is a signal flow diagram illustrating a process of independently configuring an uplink control channel and a sounding reference signal to transmit the uplink control channel and the sounding reference signal to a second base station according to an embodiment;

FIG. 6 is a signal flow diagram illustrating a process of indicating SRS related sequence information for generating an independent SRS sequence through a separate PDCCH according to another embodiment;

FIG. 7 is a signal flow diagram illustrating a process of transmitting and storing first configuration information and then transmitting second configuration information according to an embodiment;

FIG. 8 is a signal flow diagram illustrating a process of equally configuring cell-specific SRS configuration information of a first base station and a second base station according to another embodiment;

FIG. 9 is a flowchart illustrating a method of controlling a UE to transmit an uplink control channel and a sounding reference signal to another base station by a base station according to an embodiment;

FIG. 10 is a flowchart illustrating a method of transmitting an uplink control channel and a sounding reference signal to a second base station by a UE according to an embodiment;

FIG. 11 is a block diagram illustrating a configuration of a base station according to an embodiment;

FIG. 12 is a block diagram illustrating a configuration of a user equipment according to an embodiment present disclosure.

### MODE FOR CARRYING OUT THE INVENTION

In the following description, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

The wireless communication system may be widely installed so as to provide various communication services, such as a voice service, packet data, and the like. The wireless communication system may include a User Equipment (UE) and a Base Station (BS or an eNB). Throughout the specification, the user equipment may be an inclusive concept indicating a user terminal utilized in wireless communication, including a User Equipment (UE) in wideband code division multiple access (WCDMA), long term evolution (LTE), high speed packet data access (HSPA), and the like, and an Mobile station (MS), a User Terminal (UT), an Subscriber Station (SS), a wireless device, and the like in global system for mobile communications (GSM). As used herein, the user equipment may be called a UE for short.

The base station or a cell may generally refer to a station where communication with the user equipment is performed. The base station may also be referred to as a Node-B, an evolved Node-B (eNB), a Sector, a Site, a Base Transceiver System (BTS), an Access Point, a Relay Node, a Remote Radio Head (RRH), a Radio Unit (RU), a Transmission Point (TP), a Reception Point (RP), and the like.

That is, the base station 20 or the cell may be construed as an inclusive concept indicating a portion of an area covered by a Base Station Controller (BSC) in CDMA, a NodeB in WCDMA, an eNB or a sector (site) in LTE, and the like, and the concept may include various coverage areas, such as a megacell, a macrocell, a microcell, a picocell, a femtocell, a communication range of a relay node, and the like.

Since there is a base station for controlling each of various listed cells, the base station may be interpreted as having two meanings. The base station may be indicated as i) an apparatus itself for providing a mega cell, a macro cell, a micro cell, a pico cell, a femto cell, and a small cell with regard to a wireless region, or ii) the wireless region itself. In the case of i), the base station is indicated as all of apparatuses which provide a predetermined wireless region and are controlled by the same entity or apparatuses which interact with each other to configure the wireless region through a cooperative work. An embodiment of the base station corresponds to an eNB, an RRH, an antenna, an RU, an LPN, a point, a transmission/reception point, a transmission point, a reception point, etc. according to a configuration scheme of a wireless region. In the case of ii), the base station may be indicated as a wireless region itself which receives or transmits a signal from the viewpoint of a UE or a neighboring base station.

Thus, a mega cell, a macro cell, a micro cell, a pico cell, a femto cell, a small cell, an RRH, an antenna, an RU, a Lower Power Node (LPN), a point, an eNB, a transmission/reception point, a transmission point, and a reception point are referred to as the base station.

In the specification, the user equipment and the base station are used as two (uplink or downlink) inclusive transceiving subjects to embody the technology and technical concepts described in the specification and may not be limited to a predetermined term or word. Here, the Uplink (UL) refers to a scheme of performing transmission and reception of data by the user equipment with respect to the base station, and Downlink (DL) refers to a scheme of performing transmission and reception of data by the base station with respect to the user equipment.

Varied multiple access schemes may be unrestrictedly applied to the wireless communication system. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like. An embodiment of the present disclosure may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. The present disclosure may not be limited to a specific wireless communication field, and may include all technical fields in which the technical idea of the present disclosure is applicable.

Uplink transmission and downlink transmission may be performed based on a Time Division Duplex (TDD) scheme that performs transmission based on different times, or based on a Frequency Division Duplex (FDD) scheme that performs transmission based on different frequencies.

Further, in a system such as LTE and LTE-A, a standard may be developed by configuring an uplink and a downlink based on a single carrier or a pair of carriers. The uplink and the downlink may transmit control information through a control channel, such as a Physical Downlink Control Channel (PDCCH), a Physical Control Format Indicator Channel (PCFICH), a Physical Hybrid ARQ Indicator Channel (PHICH), a Physical Uplink Control Channel (PUCCH), and the like, and may be configured as a data channel, such as a Physical Downlink Shared Channel (PDSCH), a Physical Uplink Shared Channel (PUSCH), and the like, so as to transmit data.

In addition, control information may also be transmitted using an enhanced PDCCH or extended PDCCH (EPDCCH).

In the present specification, a cell may mean a coverage area of a signal transmitted from a base station, a communication system, or a transmission/reception point, a component carrier having a coverage area of a signal transmitted from a base station, a communication system, or a transmission/reception point, or a transmission/reception itself.

A wireless communication system to which embodiments are applied may be a Coordinated Multi-Point (CoMP) transmission/reception system, a coordinated multi-antenna transmission system, or a coordinated multi-cell communication system in which two or more transmission/reception points transmit a signal with a cooperative signal. The CoMP system may include at least two multi-transmission/reception point and UEs.

The multi-transmission/reception point may be at least one RRH which is controlled through a wired network while being connected to an eNB together with a base station or a macro cell (referred to as “eNB”) and has a high transmission power or a lower transmission power in a region of a macro cell.

Hereinafter, downlink implies communication or a communication path from a multi-transmission/reception point to a UE. Uplink implies communication or a communication path from a UE to a multi-transmission/reception point. In a downlink, a transmitter may be a part of a multi-transmission/reception point and a receiver may be a part of a UE. In an uplink, a transmitter may be a part of a UE and a receiver may be a part of a multi-transmission/reception point.

Hereinafter, signal transmission and reception through a channel such as a PUCCH, a PUSCH, a PDCCH, an EPDCCH, a PDSCH, etc. may be expressed as “a PUCCH, a PUSCH, a PDCCH, an EPDCCH, and a PDSCH is transmitted/received”.

Further, hereinafter, the description that a PDCCH is transmitted or received or a signal is transmitted or received through a PDCCH may be used as having a meaning including that an EPDCCH is transmitted or received or a signal is transmitted or received through an EPDCCH.

That is, a physical downlink control channel written in the below may imply a PDCCH or an EPDCCH or may be used as having a meaning including both a PDCCH and an EPDCCH. Further, for the convenience of the description, a PDCCH, which is an embodiment of the present disclosure, may be applied to a part written as a PDCCH.

Meanwhile, high layer signaling written in the below includes RRC signaling which transmits RRC information including an RRC parameter.

An eNB performs downlink transmission to UEs. The eNB may transmit a Physical Downlink Control CHannel (PDCCH) or an EPDCCH for transmitting scheduling approval information for transmission in a Physical Downlink Shared CHannel (PDSCH), which is a main physical channel for unicast transmission, downlink control information such as scheduling needed for reception of the PDSCH, and an uplink data channel (e.g., a Physical Uplink Shard CHannel (PUSCH)). Hereinafter, that a signal is transmitted/received through each channel is written as that the corresponding channel is transmitted/received.

At this time, as described with reference to the drawings below, a first UE can transmit an uplink signal to an eNB, and a second UE can transmit an uplink signal to an RRH.

The present disclosure relates to an uplink control channel, and a method and an apparatus for transmitting a sounding reference signal, and more particularly, to a method of multiplexing an uplink control channel between UEs belonging to different base stations in a deployment situation of a CoMP scenario 3 and a heterogeneous network or a CoMP scenario 4, and a method of multiplexing an uplink control channel and a sounding reference signal.

Hereinafter, the technical field to which the present disclosure pertains and the necessity of the present disclosure will be disclosed. In a communication base station according to the related art, one physical system includes a digital signal processing unit (e.g., digital signal processor) and a wireless signal processing unit (e.g., wireless signal processor). However, in the system, since a base station including all processing units (e.g., processors) is installed in a cell, the optimization of cell design is limited. In order to solve the above problem, a cell is formed in a necessary scheme by connecting a plurality of antennas to one base station, thereby reducing a coverage hole. However, such a scheme enables an efficient cell design, but it is difficult to maximize a system capacity using the scheme. Thus, a new structure and a transmission method for a bases station for maximizing a wireless capacity are required. The typical Cloud Communication Center (CCC) includes a Digital Unit (DU) of a base station and a Radio Unit (RU) for transmitting/receiving a wireless signal. The digital unit (DU) is separated from the radio unit (RU). The DU is intensively arranged in a telephone company and an RU is installed in a service region, which is unlike the existing base station system.

In such an environment, a UE is located within a coverage area of a plurality of RUs, moves the coverage area of the plurality of RUs, or receives a service from the RU at a cell edge of the plurality of RUs. That is, while the UE is located or moved, a coverage area of a downlink transmission signal transmitted by the RU and a coverage area of an uplink which the UE should transmit to the RU may be different from each other. That is, a geometry of a downlink and a geometry of an uplink of the UE may be different from each other, and uplink transmission to an RU which is different from an RU which receives a data channel and a control channel through a downlink received from a specific RU is possible.

Further, even in a heterogeneous network situation in which macro cell deployment and various small cell deployments are considered, the corresponding case may be similar. That is, the coverage area of the macro cell and the coverage area of the small cell are different from each other, and a UE, which has received data and a control channel of downlink from the macro cell, performs uplink data and controls transmission to the coverage of the small cell having a better geometry with respect to an uplink, thereby improving the reliability of uplink control information with respect to the corresponding downlink, thus, improving a data transmission rate of the downlink, further, improves the reliability of control information with respect to the uplink and the reliability of uplink data transmission, and thus, improves an uplink transmission rate.

Thus, the present disclosure is a method of supporting a UE to operate under coordination of a base station when the UE has the same transmission/reception target of an uplink and a downlink, that is, when the UE performs a transmission/reception operation for an uplink/downlink data and control channel with the same one base station and an RU, which is like a system according to the related art, and when the UE has different transmission/reception targets, which is different from a system according to the related art, that is, targets of data and control channels of the uplink and the downlink may be different from each other, and detailed methods of the present disclosure will be described below.

A Physical Uplink Control CHannel (PUCCH) used as an uplink control channel will be briefly described. A format of the corresponding uplink control channel is classified according to the type of information transmitted from a UE. Hereinafter, the type and the usage of formats of the PUCCH will be described.
PUCCH format 1
   A channel format in which only a scheduling request is transmitted.
PUCCH format 1a/1b
   A channel format through which the scheduling request and/or HARQ-ACK/NACK for a downlink data channel is transmitted and which is classified into 1a/1b according to the number of bits of ACK/NACK and a modulation scheme.
Shortened PUCCH format 1a/1b
   A channel format in which the last Single Carrier Frequency Division Multiple Access (SC-FDMA) of one sub-frame is punctured in the PUCCH format 1a/1b through which the HARQ-ACK/NACK is transmitted. Whether the corresponding format is used or not is determined on the basis of an RRC parameter by indication of a higher layer of a base station, TRUE/FALSE of “ackNackSRS-SimultaneousTransmission”, and cell specific information of an SRS.
PUCCH format 2
   A channel format through which only a Channel Quality Indicator (CQI) is transmitted.
PUCCH format 2a/2b
   A channel format through which a CQI and a response to a downlink data channel are transmitted and which is classified into 2a/2b according to the number of bits of ACK/NACK and a modulation scheme.
PUCCH format 3
   A channel format through which ACK/NACK having 4 bits or more is transmitted under downlink carrier aggregation.
Shortened PUCCH format 3
   A channel format in which the last SC-FDMA symbol of one sub-frame is punctured in the PUCCH format 3 through which ACK/NACK is transmitted. Whether the corresponding format is used or not is determined on the basis of an RRC parameter by indication of a higher layer of a base station, TRUE/FALSE of “ackNackSRS-SimultaneousTransmission”, and cell specific information of an SRS

Further, hereinafter, a sounding reference signal will be described in detail.

In the case of a Sounding Reference Signal (SRS) used for measuring an uplink channel state in order to perform frequency-dependent scheduling and for measuring a channel state of uplink/downlink in order to perform DL beamforming using channel reciprocity by a Time Division Duplex (TDD) system, parameters for generating a SRS which a UE transmits from a predetermined base station or a predetermined cell to another UE in the system according to the related art will be described as follows.

A cell-specific SRS bandwidth indicates a bandwidth required from transmitting a SRS. A transmission comb designates a frequency location required for transmitting a SRS. The frequency location is designated while being allocated with an interval of 2 sub-carriers, and for example, in the case of 0, an even number of sub-carriers are indicated and in the case of 1, an odd number of sub-carriers are indicated. A UE-specific SRS bandwidth indicates a bandwidth required from transmitting a SRS for each UE.

A base station transmits hopping related configuration parameters, a frequency domain position, and information on periodicity to a UE. Sub-frame configuration designates which sub-frame transmits a SRS. Antenna configuration designates the number of antennas which transmit a SRS, for example, the number of antenna ports. A base sequence index is a SRS sequence index for generating the corresponding SRS, and is determined on the basis of a sequence group number u used in a PUCCH and a sequence number v determined according to sequence hopping configuration. A cyclic shift index indicates a reference used when a SRS is generated. A base station transmits, to a UE, the aforementioned parameter and configuration information as higher layer signaling (e.g., a RRC parameter), and the UE receives the corresponding information and transmits an uplink SRS.

In addition, a periodic SRS and an aperiodic SRS are defined as the SRS. Various parameters are used for generating the corresponding aperiodic SRS, which is similar to the periodic SRS. The corresponding parameters for generating an aperiodic SRS which a UE transmits from a predetermined base station or a predetermined cell to another UE as used in a system according to the related art will be described as follows.

A UE-specific SRS bandwidth indicates a bandwidth required from transmitting a SRS for each UE. A transmission comb designates a frequency location required for transmitting a SRS. The frequency location is designated while being allocated with an interval of 2 sub-carriers. For example, in the case of 0, an even number of sub-carriers are indicated and in the case of 1, an odd number of sub-carriers are indicated. A base station transmits a frequency domain position and information on periodicity to a UE. A sub-frame configuration designates which sub-frame transmits a SRS. An antenna configuration designates the number of antennas which transmit a SRS, for example, the number of antenna ports. A base sequence index is a SRS sequence index for generating the corresponding SRS, and is determined on the basis of a sequence group number u used in a PUCCH and a sequence number v determined according to sequence hopping configuration. A cyclic shift index indicates a reference used when a SRS is generated.

A base station transmits the parameters to a UE through higher layer signaling (e.g., a RRC parameter). In addition, in order to transmit an aperiodic SRS, a base station dynamically triggers transmission of the aperiodic SRS to a UE through a PDCCH, and the corresponding UE receives the triggering by the PDCCH and the RRC parameters to transmit an uplink aperiodic SRS.

An operation of a UE when simultaneous transmission of an uplink PUCCH and a SRS by one sub-frame is considered will be described below.

First, when the simultaneous transmission of a PUCCH and an SRS is considered, operations of a UE are defined according to a format type of a PUCCH, and a type of a SRS, i.e., a Periodic Sounding Reference Signal (P-SRS; a type-0 SRS) and an Aperiodic SRS (A-SRS; a type-1 SRS), and further, the operations are classified and defied when a multiple component carrier is introduced.
A method of operating a UE according to a PUCCH format type of each of a P-SRS and an A-SRS

i) When simultaneous transmission of PUCCH formats 2/2a/2b and a P-SRS is generated in the same sub-frame, a UE does not transmit the P-SRS.

ii) When simultaneous transmission of PUCCH formats 2/2a/2b and an A-SRS having ACK/NACK is generated in the same sub-frame, a UE does not transmit the A-SRS.

iii) When simultaneous transmission of a PUCCH format 2 and an A-SRS is generated in the same sub-frame, a UE does not transmit the PUCCH format 2.

iv) When simultaneous transmission of a PUCCH format, which transfers both ACK/NACK and SR or one of ACK/NACK and the SR, and an SRS (here, regardless of P-SRS and A-SRS) is generated in the same sub-frame, if an RRC parameter defined by a high layer, for example, “ackNackSRS-SimultaneousTransmission” is FALSE, a UE does not transmit the SRS.

v) When simultaneous transmission of a shortened PUCCH format, which transfers both ACK/NACK and a positive SR or one of ACK/NACK and the positive SR, and an SRS (here, regardless of a P-SRS and an A-SRS) is generated in the same sub-frame, if “ackNackSRS-simultaneousTransmission” is TRUE, a UE transmits both the shortened PUCCH format and the SRS.

vi) When simultaneous transmission of a PUCCH format, which transfers both a positive ACK/NACK and a positive SR or one of the positive ACK/NACK and the positive SR, and an SRS in a specific serving cell (here, regardless of a P-SRS and an A-SRS) is generated in the same sub-frame, a UE does not transmit the SRS.

vii) “ackNackSRS-simultaneousTransmission” provided from a high layer as an RRC parameter is a parameter by which a UE determines simultaneous transmission of an SRS in a sub-frame equal to that of HARQ-ACK on a PUCCH. When the simultaneous transmission of the HARQ-ACK on a PUCCH and the SRS is determined, if the corresponding sub-frame is a cell-specific SRS sub-frame from the viewpoint of a Primary Cell (PCell) or a primary component carrier, a UE transmits the HARQ-ACK and the SR using a shortened PUCCH format. At this time, the transmission is performed using the shortened PUCCH format regardless of whether the SRS is transmitted or not in the corresponding sub-frame. Otherwise, the UE the HARQ-ACK and the SR is transmitted using the normal PUCCH formats 1/1a/1b or the normal PUCCH format 3.

In the related art, an operation of the UE for transmission to the corresponding predetermined cell/base station/RRH/antenna/RU/point is defined in a PUCCH and an SRS transmitted by a UE belonging to a predetermined cell/base station/RRH/antenna/RU/point. When the PUCCH and the SRS is transmitted to another cell/base station/RRH/antenna/RU/point, which is different from the corresponding predetermined cell/base station/RRH/antenna/RU/point, different cell/base station/RRH/antenna/RU/points indicate “ackNackSRS-SimultaneousTransmission” for each cell. Further, since configurations of cell-specific SRS sub-frames are different from each other, ambiguity in an operation of the UE is generated.

Further, from the viewpoint of multiplexing of a PUCCH at different UEs, when a UE transmits a PUCCH and an SRS to another cell/base station/RRh/antenna/RU/point, which is different from the corresponding predetermined cell/base station/RRH/antenna/RU/point, if the UE is configured to perform an operation of transmitting HARQ-ACK and/or an SR using a shortened PUCCH format, the operation being determined by the corresponding predetermined cell/base station/RRH/antenna/RU/point with respect to a PUCCH, multiplexing between UEs configured to transmit the HARQ-ACK and/or the SR using a normal PUCCH format belonging to another predetermined cell/base station/RRH/antenna/RU/point cannot be performed. In that regard, there is a disadvantage in that, from the viewpoint of one cell/base station/RRH/antenna/RU/point which receives the corresponding two signals, the multiplexing between the corresponding UEs is performed using codes having different lengths, and thus orthogonality between the UEs cannot be ensured and severe interference between different UEs is generated, and thus, data loss in a system increases.

The reverse case is the same. When a UE, which performs transmission not to a transmission cell/base station/RRH/antenna/RU/point (hereinafter, referred to as a Transmission Point (TP)) but to a reception cell/base station/RRH/antenna/RU/point (hereinafter, referred to as a Reception Point (RP)), is configured to transmit HARQ-ACK and/or an SR using a normal PUCCH format by an operation configured by the TP, and a UE belonging to another predetermined cell/base station/RRH/antenna/RU/point is configured to transmit HARQ-ACK and/or an SR using a shortened PUCCH format, the multiplexing between corresponding UEs cannot be performed.

In addition, since a UE, which receives a parameter related to a predetermined cell/base station/RRH/antenna/RU/point from the corresponding cell/base station/RRH/antenna/RU/point, performs simultaneous transmission on the basis of parameters transmitted from the corresponding predetermined cell/base station/RRH/antenna/RU/point during simultaneous transmission of a related PUCCH and a periodic/aperiodic SRS, ambiguity of the simultaneous transmission of the PUCCH and the SRS at the UE is not generated only during transmission to an uplink linked with a down link from a cell/base station/RRH/antenna/RU/point to which the corresponding UE belongs, and when transmission to an uplink which is not linked with the downlink, problems will arise in the aforementioned UEs.

The present disclosure relates to a method of enabling PUCCH multiplexing between different UEs when a UE, which belongs to a predetermined cell/base station/RRH/antenna/RU/point, i.e., has received a downlink control channel through the corresponding cell/base station/RRH/antenna/RU/point, supports transmission of an uplink control channel, i.e., a PUCCH and an SRS to another cell/base station/RRH/antenna/RU/point different from the cell/base station/RRH/antenna/RU/point having a better channel quality and a better geometry of an uplink, and relates to a detailed method and an apparatus for solving ambiguity in a UE for the transmission of a PUCCH and an SRS from the viewpoint of one UE.

The present disclosure proposes a detailed method and an apparatus for enabling a UE, which belongs to a predetermined cell/base station/RRH/antenna/RU, i.e., receives a downlink control channel through the corresponding cell/base station/RRH/antenna/RU, to support transmission to a cell/base station/RRH/antenna/RU, which is different from the cell/base station/RRH/antenna/RU having a better channel quality and a better geometry of an uplink.

Further, the present disclosure relates to a method and an apparatus for classifying an uplink channel (e.g., a PUSCH, a PUCCH, and an uplink RS (e.g., SRS)) through which transmission to a predetermined cell/base station/RRH/antenna/RU is performed and an uplink channel through which transmission to a cell/base station/RRH/antenna/RU different from the corresponding cell/base station/RRH/antenna/RU is performed, by a UE belonging to a predetermined cell/base station/RRH/antenna/RU. The classification between the corresponding channels may correspond to classification for the same channel type, i.e., classification between SRSs, PUSCHs, PUCCHs, and related RSs, and may correspond to classification between different channel types, i.e., classification between an SRS and a PUSCH, between a PUCCH and a PUSCH, and between a PUCCH and an SRS.

In detail, an embodiment of the present disclosure relates to a method and an apparatus for making a configuration such that, when N_{id}^{seq} for a base sequence of a PUCCH is independently configured to a UE from a transmission point or a first base station, the corresponding UE recognizes that transmission of a PUCCH is aimed not to the first base station but to a second base station, and follows a parameter ackNackSRS-SimultaneousTransmission for simultaneous transmission configuration of a PUCCH and an SRS of not the first base station but the second base station and cell-specific SRS sub-frame configuration follows cell-specific SRS sub-frame configuration of the second base station, and relates to a method and an apparatus for making a configuration to follow the cell-specific SRS configuration (RRC parameters included inn a SRS-related RRC message (e.g., UL-sounding-CommonConfig) such as ackNackSRS-SimultaneousTransmission, cell-specific SRS sub-frame configuration, cell-specific SRS bandwidth, etc.). This feature enables the simultaneous transmission of a PUCCH and an SRS and enables different UEs to have a UE behavior configured by the same PUCCH format (a shortened format or a normal format) between PUCCHs transmitted to the same target reception point. As a result, using the method according to the present disclosure, a UE is configured to perform multiplexing by a code having the same length between the corresponding UEs from the viewpoint of one RP and cell/base station/RRH/antenna/RU/point which receives the corresponding two signals, thereby ensuring orthogonality between PUCCHs transmitted by each of UEs.

As an example, with respect to a configuration of an independent N_{id}^{seq}, N_{id}^{seq} may be directly included in an RRC parameter, and the range of the corresponding N_{id}^{seq} may be from 0 to 509 or from 0 to 503.

Yet another example corresponds to not a method of directly including N_{id}^{seq} in an RRC parameter but a method of indicating a sequence group index and a sequence index for generating a PUCCH sequence. Here, a base sequence used for transmitting a PUCCH is configured to be derived by an equation defined in sequence group hopping and sequence hopping on the basis of the corresponding sequence group index and the sequence index.

Another embodiment of the present disclosure is a method and an apparatus for applying, to a UE, the same cell-specific SRS configuration (RRC parameters included in an SRS related RRC message (e.g., UL-sounding-CommonConfig) such as ackNackSRS-SimultaneousTransmission, cell-specific SRS sub-frame configuration, cell-specific SRS bandwidth, etc.) with respect to a CoMP coordination or cooperating set. In this case, UEs belonging to the CoMP coordination or cooperating set have the same configuration among ackNackSRS-SimultaneousTransmission parameter, thereby having the same behavior relating to simultaneous transmission of PUCCH and SRS and applying the same PUCCH format (shortened or normal) to PUCCHs transmitted to a target received point shared by the UEs. This feature enables the simultaneous transmission of a PUCCH and an SRS and enables different UEs to have a UE behavior configured by the same PUCCH format (a shortened format or a normal format) between PUCCHs transmitted to the same target reception point. As a result, using the method according to the present disclosure, a UE is configured to perform multiplexing by a code having the same length between the corresponding UEs from the viewpoint of one RP and cell/base station/RRH/antenna/RU/point which receives the corresponding two signals, thereby ensuring orthogonality between PUCCHs transmitted by each of UEs.

As described above, the sequence group index and the sequence index used in the periodic and aperiodic sounding reference signal are defined by a sequence group index u used in the PUCCH and a sequence index v defined in the sequence hopping.

A method of configuring a sequence group index u and a sequence index v used in a periodic and aperiodic sounding reference signal will be described below.

A sequence configuration method for an independent sounding reference signal will be described below.

As an example, when an aperiodic or periodic sounding reference signal is transmitted, if a sequence group index and a sequence index of a sounding reference sequence for generating the corresponding sounding reference signal are generated, the sequence group index and the sequence index are not derived and generated from a PUCCH sequence group index or a PUSCH sequence index which are based on a cell identity, but in order to generate a sequence independent of the corresponding PUCCH and PUSCH sequences, the sounding reference signal related sequences can be additionally included in a RRC configuration parameter.

Yet another example corresponds to a method of defining a parameter through a dynamically-transmitted PDCCH or an RRC parameter, and then dynamically indicating the parameter by 1 bit through the PDCCH. This corresponds to a method of making a configuration such that a sequence independent of a PUCCH and a PUSCH is generated by the corresponding sounding reference signal. This corresponds to a method of making a configuration to independently transmit a sounding reference signal to a serving cell/base station/RRH/antenna and transmit a sounding reference signal to a cell/base station/RRH/antenna/RU, which is different from the serving cell/base station/RRH/antenna/RU.

This corresponds to a method of equally configuring sequence group indexes and sequence indexes of a periodic sounding reference signal and an aperiodic sounding reference signal with respect to a sounding reference signal, independently of sequence group indexes and sequence indexes of a PUCCH and a PUSCH. That is, the sequence with respect to the sounding reference signal can be configured independent of a PUCCH and a PUSCH, so that a TDD system, which measures uplink channel qualities a serving cell/base station/RRH/antenna/RU and another cell/base station/RRH/antenna/RU and uses channel reciprocity, can be configured to independently measure qualities of downlinks of the serving cell/base station/RRH/antenna/RU and the another cell/base station/RRH/antenna/RU. Further, a location or a geometry of a UE is identified using the sounding reference signal, so a method of transmitting a UE-specific downlink during downlink transmission is used as the UE is located at a boundary or a center of a cell, thereby improving data throughput.

A case where the sequence group index and the sequence index used in the periodic sounding reference signal and the aperiodic sounding reference signal are independently allocated according to the present disclosure will be described below.

The sequence group index and the sequence index used in the periodic reference signal and the sequence group index and the sequence index used in the aperiodic reference signal can be independently allocated through an RRC parameter.

Otherwise, this corresponds to a method of including an indication for the corresponding sequence index in a dynamically-transmitted PDCCH or dynamically indicating a parameter, which is defined through an RRC parameter in advance, using 1 bit through the PDCCH. This corresponds to a method of firstly making a configuration such that a sequence independent of a PUCCH and a PUSCH can be generated by the corresponding sounding reference signal, and additionally ensuring flexibility in scheduling of a base station during transmission to a serving cell/base station/RRH/antenna/RU and another cell/base station/RRH/antenna/RU. This corresponds to a method of making a configuration to independently enable transmission to a serving cell/base station/RRH/antenna/RU and transmission to another cell/base station/RRH/antenna/RU, which is different from the serving cell/base station/RRH/antenna/RU, during transmission of the periodic reference signal and the aperiodic reference signal.

This corresponds to a method of independently configuring sequence group indexes and sequence indexes of a periodic sounding reference signal and an aperiodic sounding reference signal, independently of even sequence group indexes and sequence indexes of a PUCCH and a PUSCH.

That is, a sequence with respect to a sounding reference signal can be configured independent of a PUCCH and a PUSCH, and sequences with respect to a periodic sounding reference signal and an aperiodic sounding reference signal can be independently configured, so that a TDD system, which measures uplink channel qualities of a serving cell/base station/RRH/antenna/RU and another cell/base station/RRH/antenna/RU and uses channel reciprocity, can be configured to independently measure qualities of downlinks of the serving cell/base station/RRH/antenna/RU and the another cell/base station/RRH/antenna/RU. Further, a location or a geometry of a UE is identified using the sounding reference signal, so a method of transmitting a UE-specific downlink during downlink transmission is used as the UE is located at a boundary or a center of a cell, thereby improving data throughput.

Examples, to which the aforementioned detailed method and embodiments according to a configuration of a network are applied, will be described below.

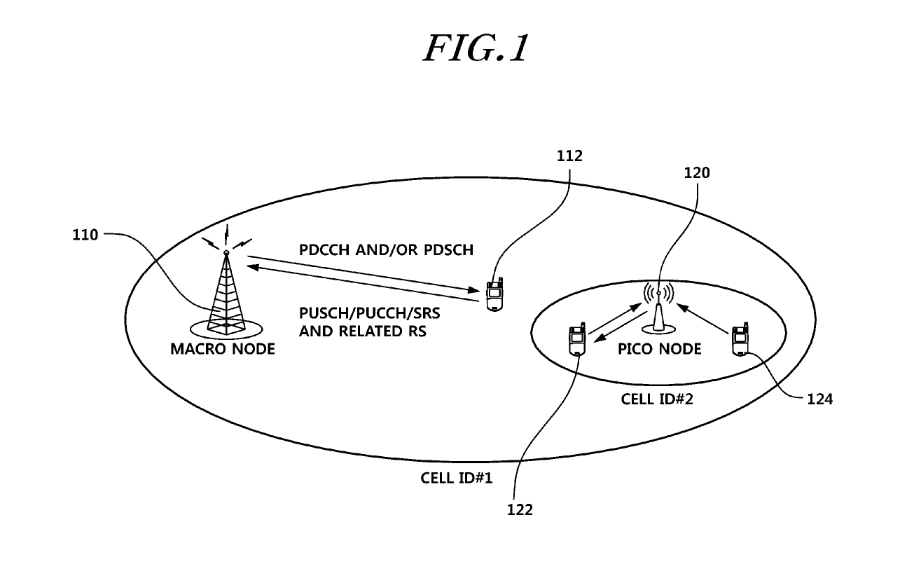

FIG. 1 illustrates a typical method of transmitting uplink/downlink data.

Referring to FIG. 1, a UE 112 transmits or receives uplink and downlink control channel and data channel, an SRS, and an RS to or from a macro node 110. Other UEs 122 and 124 transmit or receive a data channel and a control channel to or from a pico node 120. The macro node 110 and the pico node 120 have different cell IDs. In more detail, the UE 112 receives a PDCCH and/or a PDSCH from the macro node 110. The UE 112 receives PDSCH/PUCCH/SRS and a related RS from the macro node 110.

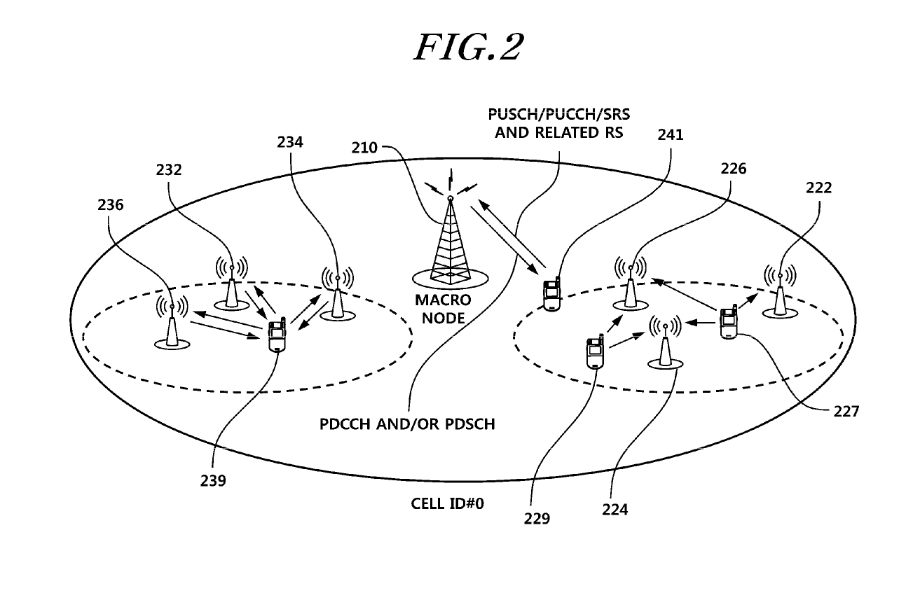

FIG. 2 illustrates a typical method of transmitting uplink/downlink data.

Referring to FIG. 2, a UE 241, at a boundary of a coverage area configured by three nodes 222, 224, and 226, transmits an uplink control channel and a data channel to a macro node 210, and receives a downlink control channel and/or a data channel from the macro node 210. In FIG. 2, the macro node 210 and six nodes 222, 224, 226, 232, 234, and 236 use one cell identity.

In the following embodiment, a cell, a Remote Radio Head (RRH), an antenna, a Radio Unit (RU), a Low Power Node (LPN), and a point are referred to as a base station. Further, a base station, to which the corresponding UE belongs, there among, is referred to as a first base station.

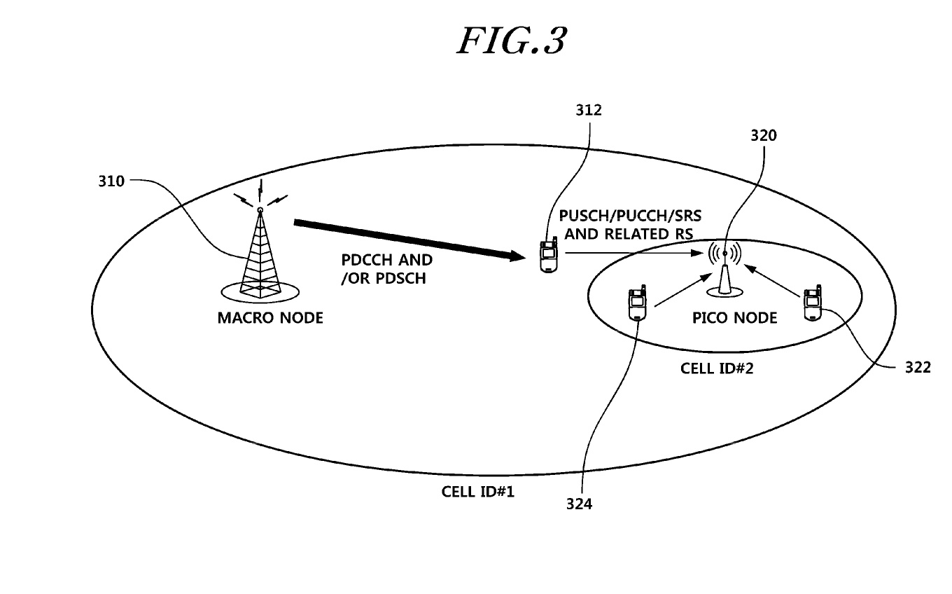

Hereinafter, various embodiments in which a UE receives a PDCCH and/or a PDSCH from the first base station to which the corresponding UE belongs, and transmits an uplink related channel to a second base station different from the first base station will be described in FIG. 3 to FIG. 10.

FIG. 3 illustrates transmission of an uplink related channel from UEs belonging to different cells to the same base station according to an embodiment of the present disclosure.

Referring to FIG. 3, a UE 312 receives a PDCCH and/or a PDSCH from a first base station or a transmission point 310, to which the corresponding UE belongs, and receives a PUCCH, a PUSCH, a sounding reference signal, and a related RS from a second base station or a reception point 320, which has a better channel quality and a better geometry. Here, the first base station and the second base station have different cell IDs. That is, the cell ID of the first base station is #1, and the cell ID of the second base station is #2. In FIG. 3, the second base station 320 has a geometry or a channel quality which is good for the UE 312.

In FIG. 3, the first base station 310 can transmit, to the UE 312, first configuration information including cell-specific SRS configuration information of the second base station 320 and second configuration information including an independent cell identifier N_{id}^{seq} for transmitting a PUCCH to the second base station 320 or a sequence group index and sequence index indication information. In this case, the first configuration information and the second configuration information may be transmitted through high layer signaling. As an example, the first configuration information and the second configuration information may be transmitted while being included in an RRC parameter. Further, before transmitting the first configuration information, the first base station equally configures cell-specific SRS configuration information of the first base station and cell-specific SRS configuration information of the second base station, and transmits the equally-configured cell-specific SRS configuration information to a UE. The second base station 320 may be a base station which performs uplink cooperative communication with the first base station 310.

Further, in FIG. 3, the first base station 310 may separately transmit, to the UE 312, the second configuration information including a sounding reference signal related sequence independent of a PUCCH and a PUDCH. Or, the first base station 310 may transmit, to the UE 312, a parameter pre-defined through a downlink control channel or an RRC parameter and then transmit 1 bit information of a downlink data channel indicating the pre-defined parameter. The above-mentioned sounding reference signal related sequence may be transmitted while being included in an RRC parameter.

The sounding reference signal related sequence or the parameter pre-defined through the downlink control channel or the RRC parameter, which is aforementioned, may be information independently configured for the periodic sounding reference signal and the aperiodic sounding reference signal.

In FIG. 3, the UE 312 may receive the aforementioned information to generate and transmit an uplink control channel and a sounding reference signal for transmitting an uplink control channel and a sounding reference signal not to the first base station 310 but to the second base station 320.

In FIG. 3, the first base station 310 and the second base station 320 have different cell IDs.

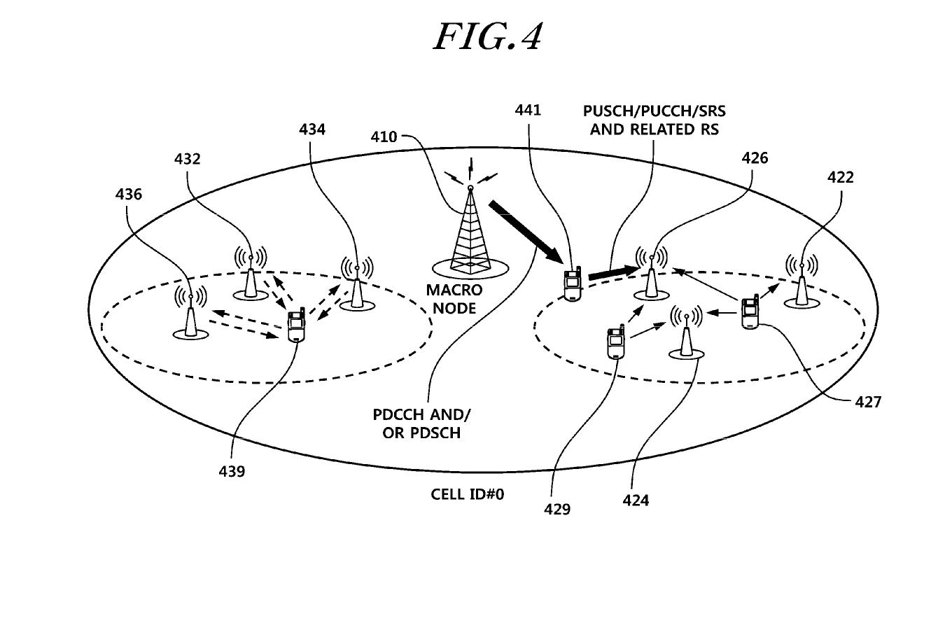

FIG. 4 illustrates transmission of an uplink related channel from UEs belonging to different base stations to the same base station according to another embodiment of the present disclosure.

In FIG. 4, a first base station 410 and a second base station 426 have the same cell ID.

In this case, the first base station 410 may transmit, to a UE 441, first configuration information including cell-specific SRS configuration information of the second base station 426 and second configuration information including an independent cell identifier N_{id}^{seq} used for generating an independent PUCCH sequence for transmitting a PUCCH to the second base station or a second group index and a sequence index indication information while the first configuration information and the second configuration information are included in high layer signaling (e.g., an RRC parameter). Further, before transmitting the first configuration information, the first base station 410 may equally configure cell-specific SRS configuration information of the first base station and the second base station. And, the first base station 410 may transmit, to the UE 441, the equally-configured cell-specific SRS configuration information while the equally-configured cell-specific SRS configuration information is included in the first configuration information. Here, the second base station 426 may be a base station which performs uplink cooperative communication with the first base station 410.

Further, in FIG. 4, the first base station 410 may separately transmit, to the UE 441, the second configuration information including a sounding reference signal related sequence independent of a PUCCH and a PUDCH. Or, the first base station 410 may transmit, to the UE 312, a parameter pre-defined through a downlink control channel or an RRC parameter and then transmit 1 bit information of a downlink data channel indicating the pre-defined parameter. The aforementioned sounding reference signal related sequence may be transmitted while being included in the high layer signaling (e.g., an RRC parameter).

The sounding reference signal related sequence or the parameter pre-defined through the downlink control channel or the RRC parameter, which is aforementioned, may be information independently configured for the periodic sounding reference signal and the aperiodic sounding reference signal.

In FIG. 4, the UE 441 may receive the aforementioned information to generate and transmit an uplink control channel and a sounding reference signal for transmitting an uplink control channel and a sounding reference signal not to the first base station 410 but to the second base station 426.

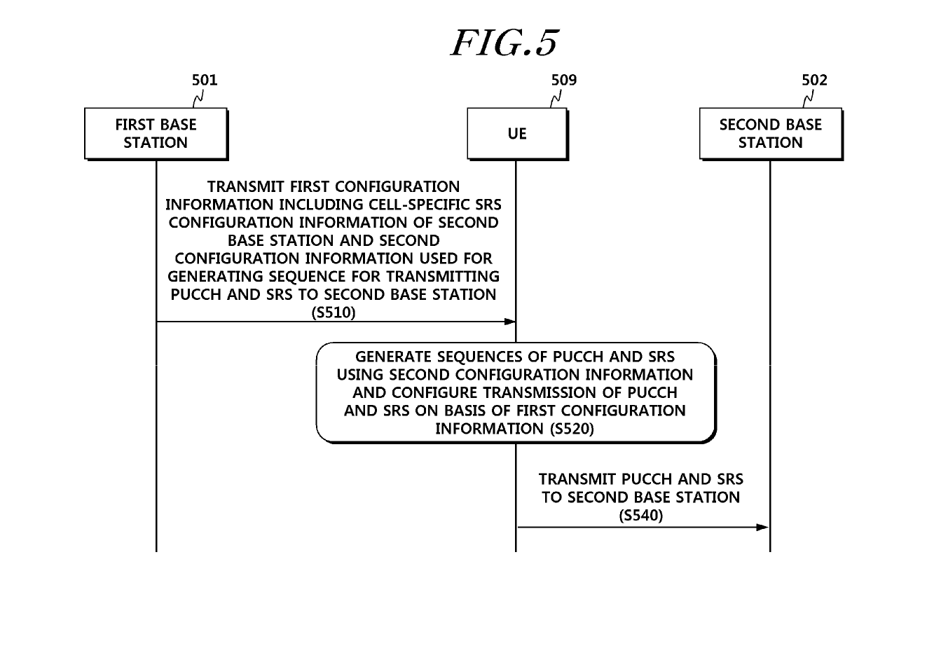

FIG. 5 is a signal flow diagram illustrating a process of independently configuring an uplink control channel and a sounding reference signal to transmit the uplink control channel and the sounding reference signal to a second base station according to an embodiment of the present disclosure.

The method performed by a UE 509 according to an embodiment of the present disclosure includes: receiving, from a first base station 501, first configuration information including cell-specific SRS configuration information of a second base station 502 which is distinguished from the first base station 501, and second configuration information including information used for generating respective sequences for transmitting the uplink control channel the sounding reference signal to the second base station 502 (S510), generating the uplink control channel and the sounding reference signal sequence on the basis of the second configuration information and configuring transmission of the uplink control channel and the sounding reference signal to the second base station 502 on the basis of the first configuration information (S520), and transmitting the configured uplink control channel and the sounding reference signal to the second base station 502 (S540).

Referring to FIG. 5, when receiving, from the first base station 501, the cell-specific SRS configuration information including a parameter required for transmitting a PUCCH and an SRS, the UE 509 receives the first configuration information including not the cell-specific SRS configuration information of the first base station 501 but the cell-specific SRS configuration information of the second base station 502 (S510).

Further, the UE 509 may receive the second configuration information while the second configuration information includes an independent cell identifier N_{id}^{seq} used for independently generating a sequence of a PUCCH in order to transmit the PUCCH and the SRS to the second base station 502. Or, the UE 509 may receive the second configuration information while the second configuration information includes indication information which indicates a sequence group index and a sequence index which are to transmit to the second base station 502 (S510).

Further, the UE 509 may receive the second configuration information including sounding reference signal related sequence information in order to configure the sounding reference signal independently of a PUCCH and a PUSCH (S510). As another embodiment, the UE 509 may receive a parameter pre-defined through a downlink control channel or an RRC parameter, and then receive 1 bit information of a downlink data channel which indicates the pre-defined parameter to independently generate an SRS sequence according to information indicating the 1 bit information.

The aforementioned first configuration information and the second configuration information may be transmitted through high layer signaling (S510), and may be transmitted while being included in, for example, an RRC parameter.

That is, the second configuration information according to an embodiment of the present disclosure may include an independent cell identifier or a sequence group index and sequence index indication information for independently generating a sequence of an uplink control channel. Such second configuration information may include the sounding reference signal related sequence information for independently generating the sounding reference signal.

Further, as another embodiment, the sounding reference signal related sequence may be configured to independently generate a periodic sounding reference signal and an aperiodic sounding reference signal.

As described above, in accordance with the present disclosure, the UE 509 stores cell-specific SRS configuration information of the corresponding second base station 502 when receiving the aforementioned first configuration information. The UE 509 recognizes that a PUCCH and an SRS are transmitted to the second base station 502 to generate a sequence of the PUCCH according to the independent cell identifier or the sequence group index and the sequence index indication information of the second configuration information when receiving the second configuration information for transmitting the PUCCH and the SRS to the second base station.

The SRS is generated on the basis of an independently-configured sounding reference signal related signal.

Thereafter, the UE 509 configures a format of the PUCCH according to an “ackNackSRS-SimultaneousTransmission” parameter included in the cell-specific SRS configuration information of the second base station 502 of the aforementioned pre-stored first configuration information, and configures SRS transmission according to SRS sub-frame configuration information. When the PUCCH and the SRS are transmitted from one sub-frame, transmission configuration of the PUCCH and the SRS is determined on the basis of the “ackNackSRS-SimultaneousTransmission” parameter, and the PUCCH and the SRS may be then transmitted to the second base station 502.

As described above, the uplink control channel is generated to be transmitted to the second base station 502, the sounding reference signal independently of the uplink control channel and the uplink data channel of the first base station 501 is generated on the basis of the first configuration information, and the uplink control channel and the sounding reference signal are transmitted, so that the multiplexing and orthogonality problem can be prevented by configuring the same uplink control channel format between uplink control channels which another UE communicating with the second base station transmits, and the ambiguity generated in the same UE 509 when the PUCCH and the SRS are transmitted from one sub-frame can be solved.

Hereinafter, the present disclosure will be described using a detailed embodiment for the first configuration information and the second configuration information.

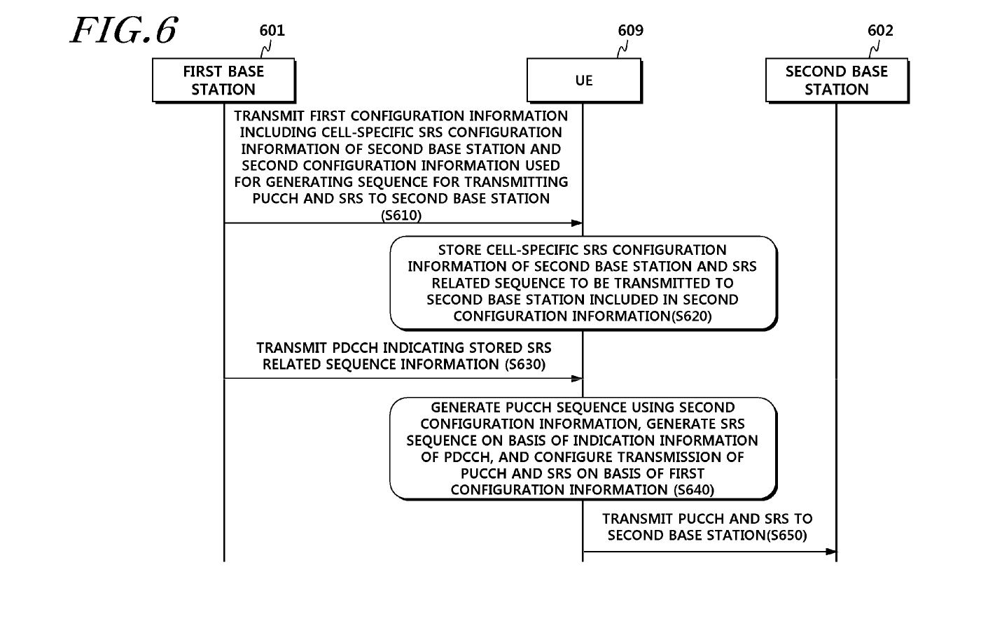

FIG. 6 is a signal flow diagram illustrating a process of indicating SRS related sequence information for generating an independent SRS sequence through a separate PDCCH according to another embodiment of the present disclosure.

The method performed by a UE 609 according to an embodiment of the present disclosure further includes: receiving first configuration information and second configuration information (S610), and then receiving a downlink control channel including 1 bit information that indicates the sounding reference signal related sequence information (S630).

Referring to FIG. 6, the first base station 601 can transmit, to the UE 609, first configuration information including cell-specific SRS configuration information of the second base station 602 and second configuration information including an independent cell identifier N_{id}^{seq} needed for generating a sequence to transmit a PUCCH to the second base station 320 or a sequence group index and sequence index indication information (S610). The range of the aforementioned N_{id}^{seq} may be from 0 to 509 or from 0 to 503.

Further, the UE 609 may receive the first configuration information including the cell-specific SRS configuration information of the second base station 602 and the second configuration information including the sounding reference signal related sequence for generating an SRS sequence in order to independently configure the SRS (S610).

In FIG. 6, after step S610, the UE 609 may store the first configuration information and the second configuration information (S620), receive, from the first base station 601, a down link control channel including 1 bit information indicating the pre-stored sounding reference signal related sequence information (S630), make a configuration to generate an SRS sequence according to the indicated sounding reference signal related sequence information and transmit a PUCCH and an SRS according to each parameter included in the first configuration information not to the first base station 601 but to the second base station 602 (S640), and transmit the PUCCH and the SRS to the second base station 602 (S650).

That is, the UE 609 may generate an uplink control channel on the basis of an independent cell identifier N_{id}^{seq} or a sequence group index and a sequence index indication information, which are received from the first base station 601 (S640). The UE 609 may generate an SRS on the basis of the sounding reference signal related sequence indicated on the basis of 1 bit indication information of the PDCCH (S640).

The UE 609 makes a configuration to transmit the generated PUCCH and the generated SRS according to an SRS sub-frame parameter and an “ackNackSRS-SimultaneousTransmission” parameter of the cell-specific SRS configuration information of the second base station 602 included in the first configuration information (S640). The UE 609 transmits the PUCCH and the SRS to the second base station 602.

Since the uplink control channel is generated on the basis of an independent cell identifier, interference with another UE already communicating with the second base station 602 can be prevented, and even when a PUCCH and an SRS are transmitted from the same UE 609 by one sub-frame, the PUCCH and the SRS are configured on the basis of the cell-specific SRS configuration information of the second base station, so that the ambiguity can be prevented.

According to another embodiment of the present disclosure, the aforementioned sounding reference signal related sequence may be configured independently of a periodic sounding reference signal and an aperiodic sounding reference signal.

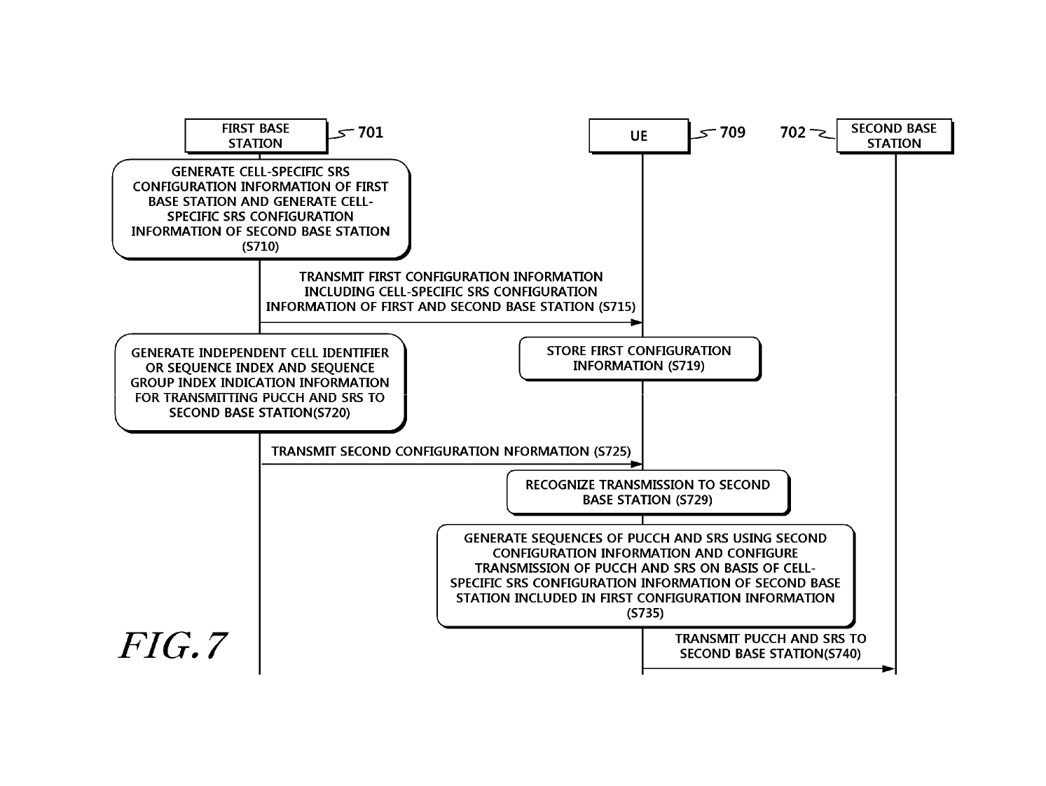

FIG. 7 is a signal flow diagram illustrating a process of transmitting and storing first configuration information and then transmitting second configuration information according to an embodiment of the present disclosure.

According to an embodiment of the present disclosure, when receiving the second configuration information after receiving the first configuration information, a UE 709 may store the first configuration information (S719). When receiving the second configuration information (S725), the UE 709 may make a configuration to transmit the uplink control channel and the sounding reference signal on the basis of the stored first configuration information (S735).

Referring to FIG. 7, a first base station 701 generates first configuration information including cell-specific SRS configuration information of the first base station and cell-specific SRS configuration information of the second base station (S710). The first base station 701 transmits the first configuration information to the UE 709 (S715). The UE stores the cell-specific SRS configuration information of the first base station and the cell-specific SRS configuration information of the second base station (S719). When receiving the second configuration information including sequence generation information of a PUCCH and an SRS for transmitting the PUCCH and the SRS to the second base station 702 (S725), the UE recognizes that the PUCCH and the SRS are transmitted not to the first base station 701 but to the second base station 702 (S729).

Thus, when receiving the second configuration information (S729), the UE 709 independently generates the PUCCH and the SRS on the basis of the second configuration information and makes a configuration to transmit the PUCCH and the SRS in a format of the PUCCH from one sub-frame on the basis of a parameter included in the pre-stored cell-specific SRS configuration information of the second base station (S735). The UE 709 transmits the PUCCH and the SRS (S740).

According to yet another embodiment of the present disclosure, the first configuration information may be cell-specific SRS configuration information of the first base station, and the cell-specific SRS configuration information of the second base station may be configured equally to the cell-specific SRS configuration information of the second base station.

Thus, when the cell-specific configuration information of the second base station is configured equally to the cell-specific SRS configuration information of the first base station, the UE 709, upon the receipt of the second configuration information according to steps S720 and S725 without receiving the first configuration information, makes a configuration to transmit the PUCCH and the SRS on the basis of the cell-specific SRS configuration information of the first base station stored in the UE, and transmits the PUCCH and the SRS.

The aforementioned first configuration information and the second configuration information may be transmitted through high layer signaling, and may be transmitted while being included in, for example, an RRC parameter.

That is, the first base station 701 may generate both of the cell-specific SRS configuration information of the first base station and the cell-specific SRS configuration information of the second base station to transmit them to the UE 709. The UE may make a configuration to transmit one of the cell-specific SRS configuration information of the first base station and the cell-specific SRS configuration information of the second base station, which are stored according to the second configuration information received from the first base station.

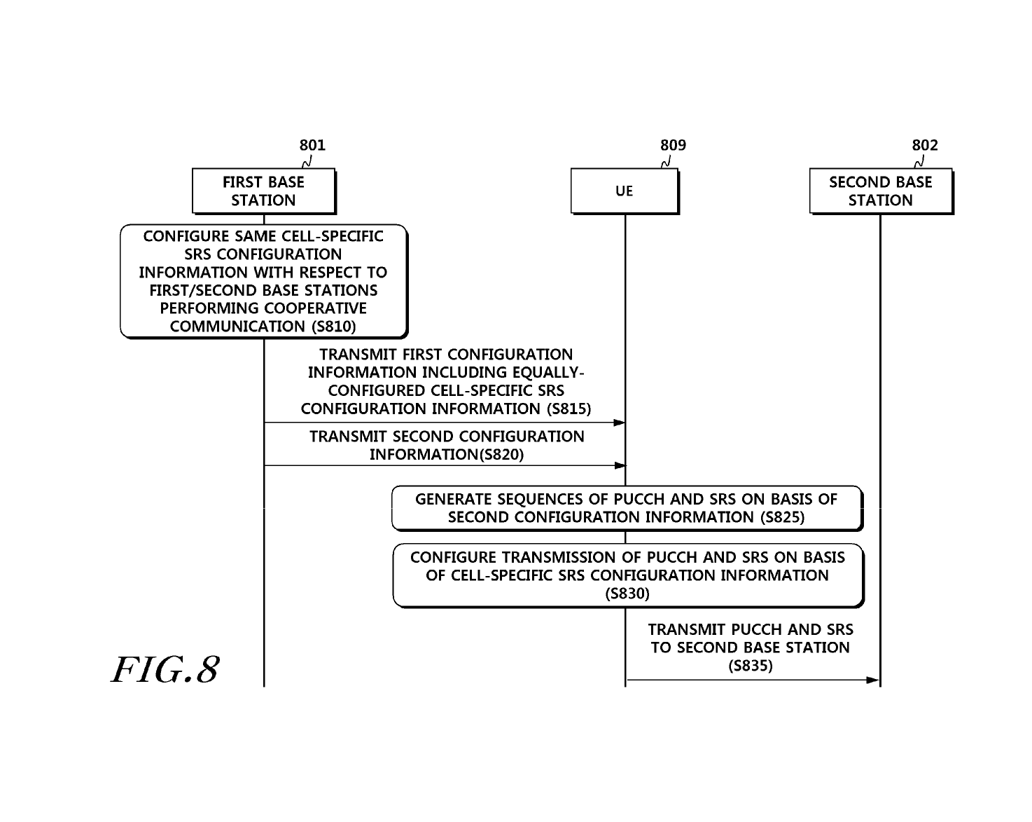

FIG. 8 is a signal flow diagram illustrating a process of equally configuring cell-specific SRS configuration information of a first base station and a second base station according to another embodiment of the present disclosure.

The method performed by a first base station 801 according to an embodiment of the present disclosure includes: generating first configuration information including cell-specific SRS information of a second base station 802 which is distinguished from a first base station and second configuration information including information used for generating respective sequences for transmitting the uplink control channel and the sounding reference signal to the second base station 802; and transmitting the first configuration information and the second configuration information to the UE through the high layer signaling. Further, the second base station receives the uplink control channel the sounding reference signal generated using the first configuration information and the second configuration information.

Further, when generating the first configuration information and the second configuration information, the first base station 801 according to another embodiment of the present disclosure may configure cell-specific SRS configuration information of the first base station equally to cell-specific SRS configuration information of the second base station, and may generate the first configuration information while the first configuration information includes the equally-configured cell-specific SRS configuration information (S810).

Referring to FIG. 8, when the first base station transmits the first configuration information to the UE 809, the cell-specific SRS configuration information of the second base station 802 which performs cooperative communication with the second base station 801 and the cell-specific SRS configuration information of the first base station may be equally configured (S810).

The equally-configured cell-specific SRS configuration information is transmitted to a UE through high layer signaling while being included in the first configuration information (S815). When the second configuration information including the information used for generating a sequence for transmitting a PUCCH and an SRS to the second base station is transmitted to the UE 809 (S820), the UE 809 generates the PUCCH and the SRS on the basis of the first configuration information and the second configuration information in which the cell-specific SRS configuration information of the first base station and the second base station is equally configured (S825 and S830) and transmits the PUCCH and the SRS.

In this case, the first base station 801 and the second base station 802 may equally configure cell-specific SRS configuration information through an X2 interface. The first base station may generate the cell-specific SRS configuration information equal to that of the second base station. The first base station may make a command to change the cell-specific SRS configuration information of the second base station to the cell-specific SRS configuration information of the first base station.

Further, third cell-specific SRS configuration information may be used as the cell-specific SRS configuration information of the first base station and the second base station.

As described in FIG. 8, in a case where the cell-specific SRS configuration information of the first base station and the cell-specific SRS configuration information of the second base station are equally configured, the UE may transmit the PUCCH and the SRS while equally configuring a SRS sub-frame configuration parameter. In this case, the UE may also transmit the PUCCH and the SRS by one sub-frame with the same configuration according to the same “ackNackSRS-SimultaneousTransmission” parameter. Further, since the PUCCH format is generated on the basis of the same “ackNackSRS-SimultaneousTransmission” parameter, the format length of the PUCCH connected with another UE communicating with the second base station is configured, so that influence on an interference signal can be reduced.

Hereinafter, a process of independently generating a sounding reference signal and transmitting the sounding reference signal on the basis of cell specific SRS configuration information of a second base station will be described in detail.

When an aperiodic or periodic sounding reference signal is transmitted and if a sequence group index and a sequence index of a sounding reference sequence for generating the corresponding sounding reference signal are generated, the sequence group index and the sequence index are not derived and generated from a PUCCH sequence group index or a PUSCH sequence index which are based on a cell identity. However, in order to generate a sequence independent of the corresponding PUCCH and PUSCH sequences, the sounding reference signal related sequences can be additionally generated and be transmitted through high layer signaling (e.g., an RRC configuration parameter) while being included in the second configuration information.

This corresponds to a method of making a configuration such that a sequence independent of a PUCCH and a PUSCH is generated by the corresponding sounding reference signal.

The UE generates a sounding reference signal using the aforementioned independent sounding reference signal related sequences and transmits the generated sounding reference signal to the second base station.

In this case, transmission of the sounding reference signal to the first base station and transmission of the sounding reference signal to the second base station may be performed independently.

Further, according to yet another embodiment for generating an independent sounding reference signal sequence, as described above, the sounding reference signal related sequence independent of the second configuration information are transmitted in advance through a dynamically-transmitted PDCCH and an RRC parameter, and the UE stores an independent sounding reference signal related sequence parameter.

Thereafter, the first base station transmits information indicating the pre-stored independent sounding reference signal related parameter using 1 bit in the PDCCH. The UE, which has received the indication information from the first base station, independently generate a sounding reference signal on the basis of the indicated independent sounding reference signal related parameter, and transmits the generated sounding reference signal to the second base station.

Further, according to yet another embodiment of the present disclosure, the independently-configured sounding reference signal related sequence may be configured again independently of the periodic sounding reference signal and the aperiodic sounding reference signal.

That is, the first base station independently transmits a sequence group index and a sequence index used in the periodic reference signal and a sequence group index and a sequence index used in the aperiodic reference signal through an RRC parameter, and the UE generates a sounding reference signal on the basis of the sequence group index and the sequence index used in the periodic reference signal and the sequence group index and the sequence index used in the aperiodic reference signal to transmit the periodic sounding reference signal and the aperiodic sounding reference signal to the second base station. This corresponds to a method of making a configuration to independently enable transmission to a serving cell/base station/RRH/antenna/RU/point (first base station) and transmission to another cell/base station/RRH/antenna/RU/point (second base station), which is different from the serving cell/base station/RRH/antenna/RU/point, during transmission of the periodic reference signal and the aperiodic reference signal. Further, the UE may perform transmission to the first base station as well as the second base station.

Embodiments of the present disclosure, which have been described, will be described again.

From the first base station, the UE may receive the first configuration information including the cell-specific SRS configuration information of the second base station. From the first base station, the UE may receive the cell identifier N_{id}^{seq} independent of a cell identifier of the first base station in order to generate the independent sequence of the uplink control channel as the second configuration information, or, the UE may receive the information indicating the sequence group index and the sequence index for generating the independent sequence.

Further, in order to generate the independent sounding reference signal, the UE may receive, from the first base station, the independent sounding reference signal related sequence included in the second configuration information. Or, the UE may receive 1 bit indication information which indicates a pre-defined parameter while being included in the PDCCH or the RCC parameter.

The UE may generate the PUCCH and the SRS on the basis of the received second configuration information independently of the first base station, between the same channels (i.e., SRSs, PUCCHs) or between different channels (between the SRS and the PUCCH).

Further, the cell-specific SRS configuration information of the second base station included in the first configuration information regarding the transmission configuration is used to transmit the generated PUCCH and the SRS to the second base station.

In detail, the PUCCH format is configured using the cell-specific SRS sub-frame configuration parameter and the “ackNackSRS-SiumltaneousTransmission” parameter which are included in the cell-specific SRS configuration information of the second base station. The PUCCH format is transmitted to the second base station after configuring a transmission form of when the PUCCH and the SRS are transmitted from one frame.

As yet another embodiment of the present disclosure, proposed is a method of configuring cell-specific SRS configuration information of a first base station equally to cell-specific SRS configuration information of a second base station which performs cooperative communication and then transmitting the cell-specific SRS configuration information to a UE.

Further, a method of transmitting a sounding reference signal related sequence while the sounding reference signal related sequence is included in an RRC parameter and a method of indicating a pre-defined parameter using 1 bit of a PDCCH have been described as a method of transmitting, to a UE, a separate sounding reference signal related sequence independent of a PUCCH sequence and a PUSCH sequence in order to generate an independent periodic/aperiodic sounding reference signal regarding a sounding reference signal.

Further, a case, in which a sounding reference signal related sequence for generating a periodic sounding reference signal and a sounding reference signal related sequence for generating an aperiodic sounding reference signal are independent there between, has been described.

Hereinafter, a process, in which the embodiments described in FIG. 5 to FIG. 8 are performed by the first base station or the UE, will be mainly described.

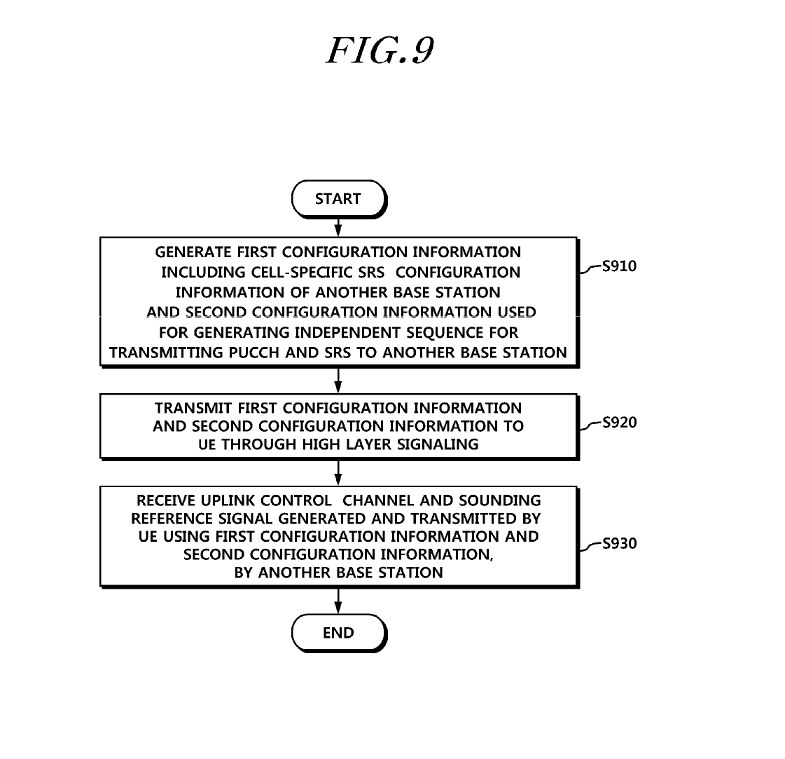

FIG. 9 is a flowchart illustrating a method of controlling a UE to transmit an uplink control channel and a sounding reference signal to another base station by a base station according to an embodiment of the present disclosure.

In FIG. 9, a base station generates first configuration information including cell-specific SRS configuration information of another base station and a base sequence used for transmitting an uplink control channel, generates high layer signaling including second configuration information for generating an independent SRS (S910). And the base station transmits, to a UE, high layer signaling including the generated first configuration information and the generated second configuration information (S920). The another base station, which is different from the base station, receives the uplink control channel and/or the sounding reference signal, which are generated by using the first configuration information and the second configuration information (S930).

As described in FIG. 5 to FIG. 8, the second configuration information corresponds to an independent cell identifier. The second configuration information includes the sequence group index and the sequence index indication information for transmitting the uplink control channel to the another base station. The second configuration information includes the sounding reference signal related sequence information for independently configuring the sounding reference signal.

Further, according to another embodiment of the present disclosure, the cell-specific SRS configuration of the base station is information configured equally to the cell-specific SRS configuration of the another base station. The another base station is a base station which performs uplink cooperative communication with the base station.

The first configuration information includes the cell-specific SRS configuration information of the another base station. The first configuration information may be transmitted through the high layer signaling (e.g., the RRC parameter).

As described in FIG. 7, according to another embodiment of the present disclosure, the first configuration information may be the cell-specific SRS configuration information of the base station. The cell-specific SRS configuration information of the base station may be configured equally to the cell-specific SRS configuration information of the another base station which receives the sounding reference signal and the uplink control channel.

Further, the sounding reference related sequence transmitted while being included in the second configuration information with regard to generation of the independent sounding reference signal or the parameter pre-defined through the downlink control channel or the RRC parameter may be configured independently of the periodic sounding reference signal and the aperiodic sounding reference signal.

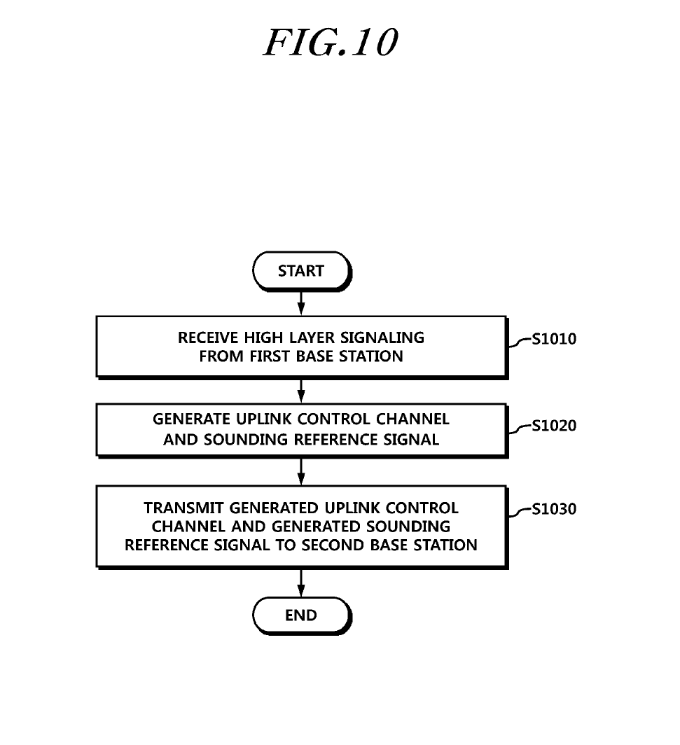

FIG. 10 is a flowchart illustrating a method of transmitting an uplink control channel and a sounding reference signal to a second base station by a UE according to an embodiment of the present disclosure.

In FIG. 10, a UE receives, from a first base station, first configuration information including cell-specific SRS configuration information of a second base station and second configuration information including information for generating a base sequence used for transmitting an uplink control channel and a sounding reference signal to the second base station through high layer signaling (e.g., an RRC parameter) (S1010).

The UE generates the uplink control channel and the sounding reference signal to be transmitted to the second base station, on the basis of the received first configuration information and the received second configuration information. That is, when receiving the second configuration information, the UE recognizes that the transmission is targeted not to the first base station but to the second base station, to generate an independent uplink control channel and/or a sounding reference signal on the basis of the second configuration information, and configures a format of an uplink control channel, transmission sub-frame information of a sounding reference signal, an operation of when the uplink control channel and the sounding reference signal are transmitted from one sub-frame, etc. by using an SRS sub-frame parameter and an “ackNackSRS-SimultaneousTransmission” parameter included in the cell-specific SRS configuration information of the second base station included in the first configuration information.

The UE transmits the configured uplink control channel and/or the configured sounding reference signal to the second base station, which is distinguished from the first base station (S1030).

In detail, as described in FIG. 5 to FIG. 8, the first configuration information is the cell-specific SRS configuration information of the second base station. The first configuration information is the cell-specific SRS configuration information of the first base station configured equally to the cell-specific SRS configuration information of the second base station according to another embodiment. Further, the second configuration information may include the independent cell identifier for independently generating an uplink control channel, or the sequence group index and the sequence index indication information for transmitting an uplink control channel to the second base station. The second configuration information may include the sounding reference signal related sequence information for generating an independent sounding reference signal. Further, in another embodiment, the periodic and aperiodic sounding reference signal related sequences may be independent of each other. In yet another embodiment, the method further includes receiving 1 bit information of a downlink control channel indicating the independent sounding reference signal related sequence information. The second base station is a base station which performs uplink cooperative communication with the first base station.

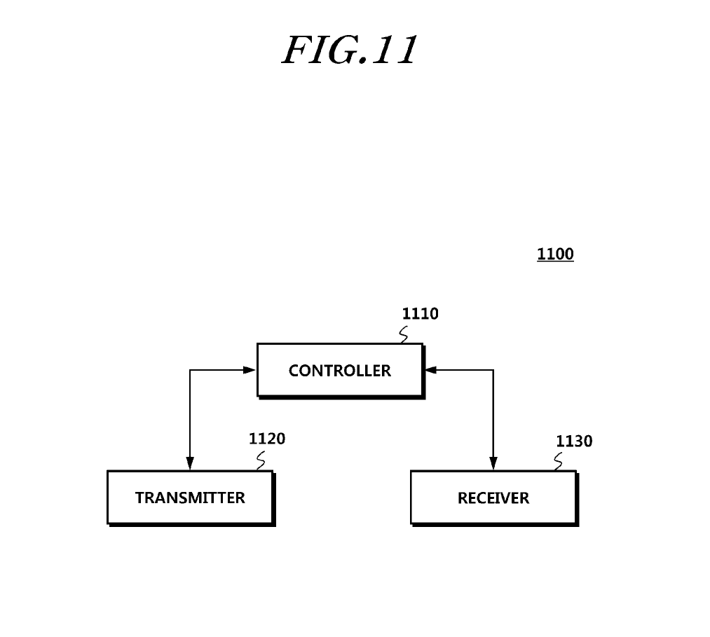

FIG. 11 is a block diagram illustrating a configuration of a base station according to an embodiment of the present disclosure.

Referring to FIG. 11, a base station 1100 according to an embodiment of the present disclosure includes a controller 1110, a transmitter 1120 (e.g., transmission unit 1120), and a receiver 1130 (e.g., reception unit 1130).

The controller 1110 controls an overall operation of the base station 110 which generates the first configuration information including the cell-specific SRS configuration information of another base station and the second configuration information needed for generating the uplink control channel and the sounding reference signal and transmits the generated first configuration information and the generated second configuration information to the UE, which are needed for performing the aforementioned present disclosure.

Further, the controller 1110 may control an operation of equally configuring the cell-specific SRS configuration information of the base station and the cell-specific SRS configuration information of the another base station according to another embodiment of the present disclosure.

The transmitter 1120 and the receiver 1130 are used for transmitting/receiving a signal, a message, and data needed for performing the aforementioned present disclosure to/from a UE.

The receiver 1130 may receive an uplink related channel from a UE, and the transmitter 1120 may transmit the first configuration information and the second configuration information which are generated by the controller 1110 and may transmit a downlink signal.

In accordance with at least one embodiment, the base station 1100 may be a cell/RRH/antenna/RU/LPN/point as described above.

The base station 1100 performs operations described in detail with reference to FIG. 5 to FIG. 10. The operations described with FIG. 5 to FIG. 10 are applied to the base station 1100 in FIG. 11.

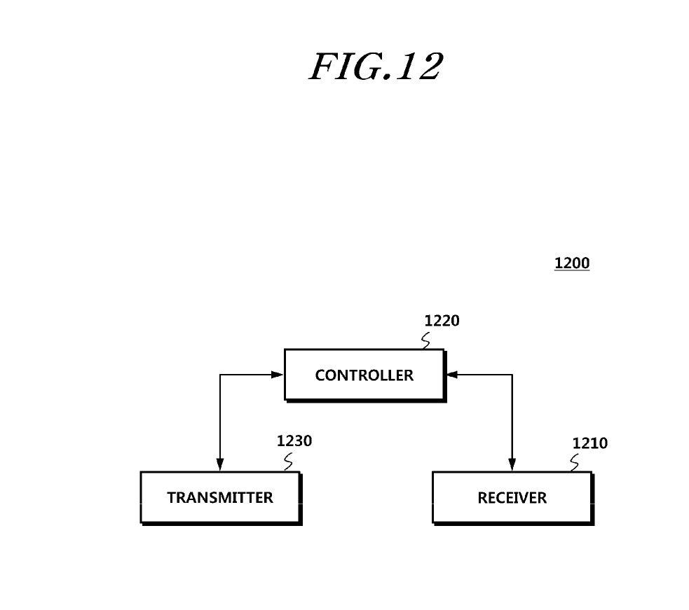

FIG. 12 is a block diagram illustrating a user equipment according to an embodiment of the present disclosure.

Referring to FIG. 12, a user equipment 1200 according to an embodiment of the present disclosure includes a receiver 1210 (e.g., reception unit 1210), a controller 1220, and a transmitter 1230 (e.g., transmission unit 1230).

From a first base station, the receiver 1210 receives downlink control information, data, and a message through the corresponding channel. The receiver 1210 also receives first configuration information and second configuration information needed for generating an uplink control channel and a sounding reference signal through high layer signaling according to an embodiment of the present disclosure.

Further, the controller 1220 controls an overall operation of the UE which generates an uplink control channel and a sounding reference signal on the basis of first configuration information and second configuration information and transmits the generated uplink control channel and the generated sounding reference signal to the second base station.

The transmitter 1230 transmits, to the first and second base stations, uplink control information, data, and a message through the corresponding channel. The transmitter 1230 transmits, to the second base station, the uplink control channel and/or the sounding reference signal generated by the controller 1220.

The standard and the standard documents mentioned in the above embodiments are omitted for simplifying the description of the specification, and configure a part of the present specification. Thus, adding a part of the contents relating to the standard contents and the standard documents or describing the part of the contents in claims is interpreted to correspond to the scope of the present disclosure.

In accordance with at least one embodiment, the UE performs operations already described with reference FIG. 5 to FIG. 8. Such described operations are applied to the UE in FIG. 12.

As described above, the present disclosure enables a UE, which belongs to a predetermined cell/base station/RRH/antenna/RU, i.e., receives a downlink control channel through the corresponding cell/base station/RRH/antenna/RU, to support transmission to a cell/base station/RRH/antenna/RU, which is different from the cell/base station/RRH/antenna/RU having a better channel quality and a better geometry of an uplink, thereby overcoming a coverage of the PUCCH and the PUSCH of the uplink. Further, the present disclosure can measure a state of an uplink channel with another cell/base station/RRH/antenna/RU, which is different from the serving cell/base station/RRH/antenna/RU, through transmission of a periodical or aperiodical sounding reference signal, thereby overcoming coverage shortages of an uplink.

Although the embodiments of the present disclosure have been described for illustrative purposes, those skilled in the art will appreciate that various modifications, additions and substitutions are possible, without departing from the scope and spirit of the invention. Therefore, exemplary embodiments of the present disclosure have been described for the sake of brevity and clarity. The scope of the present disclosure shall be construed on the basis of the accompanying claims in such a manner that all of the technical ideas included within the scope equivalent to the claims belong to the present disclosure.

### CROSS-REFERENCE TO RELATED APPLICATION

This application claims priority from and the benefit under 35 U.S.C. §119(a) of Korean Patent Application Nos. 10-2012-0089754, filed on Aug. 16, 2012 and 10-2013-0089752, filed on Jul. 29, 2013.

1. A method of transmitting an uplink control channel and a sounding reference signal by a user equipment (UE), the method comprising:
receiving first configuration information and second configuration information where the first configuration information includes cell-specific SRS configuration information of a second base station which is distinguished from a first base station transmitting a downlink signal and the second configuration information includes information used for generating respective sequences for transmitting the uplink control channel and the sounding reference signal to the second base station;
generating the respective of the uplink control channel and the sounding reference signal on the basis of the second configuration information, and configuring transmission of the uplink control channel and the sounding reference signal to the second base station on the basis of the first configuration information; and
transmitting the configured uplink control channel and the configured sounding reference signal to the second base station.

2. The method of claim 1, wherein:
the second configuration information comprises an independent cell identifier or a sequence group index and sequence index indication information for independently generating a sequence of the uplink control channel, and sounding reference signal related sequence information for independently generating the sounding reference signal; and
the second configuration information is included in a Radio Resource Control (RRC) parameter.

3. The method of claim 2, further comprising: after the receiving the first configuration information and the second configuration information, receiving a downlink control channel including 1 bit information indicating the sounding reference signal related sequence information.

4. The method of claim 2, wherein the sounding reference signal related sequence is configured independently of each of a periodic sounding reference signal and an aperiodic sounding reference signal.

5. The method of claim 1, wherein:
when the second configuration information is received after the first configuration information is received, the UE stores the first configuration information; and
when the second configuration information is received, the method comprises configuring the transmission of the uplink control channel and the sounding reference signal on the basis of the stored first configuration information.

6. The method of claim 1, the configuring of the transmission of the uplink control channel and the sounding reference signal comprises:
configuring the transmission of the sounding reference signal on the basis of cell-specific SRS sub-frame information of the second base station included in the first configuration information; and
configuring a format of the uplink control channel and the transmission of the uplink control channel and the sounding reference signal on the basis of an “ackNackSRS-SimultaneousTransmission” parameter of the second base station.

7. A method of controlling transmission of an uplink control channel and a sounding reference signal of a UE by a base station, the method comprising:
generating first configuration information and second configuration information where the first configuration information includes cell-specific SRS configuration information of another base station which is distinguished from the base station and the second configuration information includes information used for generating respective sequences for transmitting the uplink control channel and the sounding reference signal to the another base station; and
transmitting the first configuration information and the second configuration information to the UE through high layer signaling,
wherein the another base station receives the uplink control channel and the sounding reference signal and the uplink control channel and the sounding reference signal are generated using the first configuration information and the second configuration information.

8. The method of claim 7, wherein:
the second configuration information comprises one of an independent cell identifier and a sequence group index and sequence index indication information for independently generating a sequence of the uplink control channel;
the second configuration information comprises sounding reference signal related sequence information for independently generating the sounding reference signal; and
the second configuration information is included in an RRC parameter.

9. The method of claim 8, further comprising, after the generating of the first configuration information and the second configuration information:
generating a downlink control channel including 1 bit information indicating the sounding reference signal related sequence information; and
transmitting the generated downlink control channel to the UE.

10. The method of claim 8, wherein the sounding reference signal related sequence is configured independently of each of a periodic sounding reference signal and an aperiodic sounding reference signal.

11. The method of claim 7, wherein in the generating of the first configuration information and the second configuration information, the base station configures cell-specific SRS configuration information of the base station equally to cell-specific SRS configuration information of the another base station, and generates the first configuration information while the first configuration information includes the equally-configured cell-specific SRS configuration information.

12. A user equipment (UE) comprising:
a receiver configured to receive, from a first base station, first configuration information and a second configuration information where the first configuration information includes cell-specific SRS configuration information of a second base station which is distinguished from a first base station transmitting a downlink signal and the second configuration information includes information used to generate respective sequences for transmitting the uplink control channel and the sounding reference signal to the second base station;
a controller configured to generate respective sequences of the uplink control channel and the sounding reference signal on the basis of the second configuration information, and to configure transmission of the uplink control channel and the sounding reference signal to the second base station on the basis of the first configuration information; and
a transmitter configured to transmit the configured uplink control channel and the configured sounding reference signal to the second base station.

13. The UE of claim 12, wherein:
the second configuration information comprises one of an independent cell identifier and a sequence group index and sequence index indication information to independently generate a sequence of the uplink control channel;
the second configuration information comprises sounding reference signal related sequence information to independently generate the sounding reference signal; and
the second configuration information is included in an RRC parameter.

14. The UE of claim 13, wherein after receiving the first configuration information and the second configuration information, the receiver further receives a downlink control channel including 1 bit information indicating the sounding reference signal related sequence information.

15. The UE of claim 12, wherein, in a case where the second configuration information is received after the first configuration information is received, when the second configuration information is received after the first configuration information is stored, the controller configures transmission of the uplink control channel and the sounding reference signal on the basis of the stored first configuration information.

16. The UE of claim 12, wherein the controller is configured to:
configure transmission of the sounding reference signal on the basis of cell-specific SRS sub-frame information of the second base station included in the first configuration information; and
configure a format of the uplink control channel and the transmission of the uplink control channel and the sounding reference signal on the basis of an “ackNackSRS-SimultaneousTransmission” parameter of the second base station.

17. (canceled)

18. (canceled)

19. (canceled)

20. (canceled)
